(19) United States
(12) Patent Application Publication
(10) Pub. No.: US 2021/0041335 A1
(43) Pub. Date: Feb. 11, 2021

(54) DISSOLUTION MONITORING METHOD AND APPARATUS

(71) Applicant: Micro Motion, Inc., Boulder, CO (US)

(72) Inventor: Justin Craig HOLLINGSWORTH, Fort Collins, CO (US)

(73) Assignee: Micro Motion, Inc., Boulder, CO (US)

(21) Appl. No.: 16/969,129

(22) PCT Filed: Feb. 23, 2018
(86) PCT No.: PCT/US2018/019497

§ 371 Date: Aug. 11, 2020

(51) Int. Cl. G01N 9/00; G01N 13/00

(52) U.S. Cl. CPC G01N 9/002; G01N 2009/006; G01N 2013/006; G01N 13/00

(57) ABSTRACT

A vibratory meter (5, 200) is provided, having a driver (104, 202) and a vibratory member (103, 103′, 204) vibratable by the driver (104, 202). At least one pickoff sensor (105, 105′, 209) is configured to detect vibrations of the vibratory member (103, 103′, 204). Meter electronics (20) comprise an interface (301) configured to receive a vibrational response from the at least one pickoff sensor (105, 105′, 209), and a processing system (303) coupled to the interface (301). The processing system (303) is configured to measure a drive gain (306) of the driver (104, 202) and determine a solute added to the fluid is substantially fully dissolved based upon the drive gain (306).

### TECHNICAL FIELD

The present invention relates to vibratory meters, and more particularly, to a method and apparatus for monitoring dissolution of solutes in a solvent.

### BACKGROUND OF THE INVENTION

Densitometers are generally known in the art and are used to measure a density of a fluid. The fluid may comprise a liquid, a gas, a liquid with suspended particulates and/or entrained gas, or combinations thereof. Vibratory densitometers typically operate by detecting motion of a vibrating element that vibrates in the presence of a fluid material to be measured. Properties associated with the fluid material, such as density, viscosity, temperature, and the like, can be determined by processing measurement signals received from motion transducers associated with the vibrating element. The vibration modes of the vibrating element system generally are affected by the combined mass, stiffness, and damping characteristics of the vibrating element and the surrounding fluid material.

Vibrating densitometers and Coriolis flowmeters are generally known, and are used to measure mass flow and other information related to materials flowing through a conduit in the flowmeter or a conduit containing the densitometer. Exemplary flowmeters are disclosed in U.S. Pat. Nos. 4,109,524, 4,491,025, and Re. 31,450, all to J. E. Smith et al. These flowmeters have one or more conduits of a straight or curved configuration. Each conduit configuration in a Coriolis mass flowmeter, for example, has a set of natural vibration modes, which may be of simple bending, torsional, or coupled type. Each conduit can be driven to oscillate at a preferred mode. Some types of mass flowmeters, especially Coriolis flowmeters, are capable of being operated in a manner that performs a direct measurement of density to provide volumetric information through the quotient of mass over density. See, e.g., U.S. Pat. No. 4,872,351 to Ruesch for a net oil computer that uses a Coriolis flowmeter to measure the density of an unknown multiphase fluid. U.S. Pat. No. 5,687,100 to Buttler et al. teaches a Coriolis effect densitometer that corrects the density readings for mass flow rate effects in a mass flowmeter operating as a vibrating tube densitometer.

Material flows into the flowmeter from a connected pipeline on the inlet side of the flowmeter, is directed through the conduit(s), and exits the flowmeter through the outlet side of the flowmeter. The natural vibration modes of the vibrating system are defined in part by the combined mass of the conduits and the material flowing within the conduits.

Another example of a vibratory density meter operates on the vibrating element principle, wherein the element is a slender tuning fork, or similar structure, which is immersed in the liquid being measured. A conventional tuning fork consists of two tines, typically of flat or circular cross section, that are attached to a cross beam, which is further attached to a mounting structure. The tuning fork is excited into oscillation by a driver, such as a piezo-electric crystal for example, which is internally secured at the root of the first tine. The frequency of oscillation is detected by a second piezo-electric crystal secured at the root of the second tine. The transducer sensor may be driven at its first natural resonant frequency, as modified by the surrounding fluid, by an amplifier circuit located with the meter electronics.

When the fork is immersed in a fluid and excited at its resonant frequency, the fork will move fluid via the motion of its tines. The resonant frequency of the vibration is strongly affected by the density of the fluid these surfaces push against. According to well-known principles, the resonant frequency of the tines will vary inversely with the density of the fluid that is contacting the conduit.

Meter electronics connected via a vibratory meter driver generate a drive signal to operate the driver and also to determine a density and/or other properties of a process material from signals received from the pickoffs. The driver may comprise one of many well-known arrangements such as a piezo driver or a magnet having an opposing drive coil. An alternating current is passed to the driver for vibrating the conduit(s) at a desired amplitude and frequency. It is also known in the art to provide the pickoffs in an arrangement very similar to the driver arrangement. However, while the driver receives a current which induces a motion, the pickoffs can use the motion provided by the driver to induce a voltage. The magnitude of the time delay measured by the pickoffs is very small; often measured in nanoseconds. Therefore, it is necessary to have the transducer output be very accurate.

Other styles of vibrating densitometers can comprise a cylindrical vibratory member that is exposed to a fluid under test. One example of a vibrating densitometer comprises a cylindrical conduit that is cantilever-mounted, with an inlet end coupled to an existing pipeline or other structure, and with the outlet end free to vibrate. The conduit can be vibrated and a resonant frequency can be measured, which allows determination of the density of the fluid under test.

A method and apparatus for monitoring the dissolution of solutes, especially in batch mixing operations, is provided that utilizes densitometry. A vibrating element density meter is utilized to monitor mixing operations. A system with a recirculation loop may be provided wherein a vibrating member densitometer is utilized to measure solute dissolution.

### SUMMARY OF THE INVENTION

A vibratory meter is provided according to an embodiment. The vibratory meter comprises a driver, a vibratory member vibratable by the driver, and at least one pickoff sensor configured to detect vibrations of the vibratory member. Meter electronics is provided that comprises an interface configured to receive a vibrational response from the at least one pickoff sensor, and a processing system coupled to the interface configured to measure a drive gain of the driver and determine that a solute added to the fluid is substantially fully dissolved based upon a change in the drive gain.

A method of monitoring solute dissolution in a solution is provided according to an embodiment. The method comprises the steps of adding a first solute to a fluid and exposing the fluid to a vibratory meter. A drive gain of a driver of the vibratory meter is measured, and the first solute is determined to have substantially fully dissolved based upon a change in the measured drive gain.

### ASPECTS

According to an aspect, a vibratory meter, comprises a driver, a vibratory member vibratable by the driver, at least one pickoff sensor configured to detect vibrations of the vibratory member, meter electronics comprising an interface configured to receive a vibrational response from the at least one pickoff sensor, and a processing system coupled to the interface configured to measure a drive gain of the driver and determine a solute added to the fluid is substantially fully dissolved based upon a change in the drive gain.

Preferably, the processing system is configured to measure a density of a fluid and determine a solute added to the fluid is substantially fully dissolved based upon a change in the density of the fluid.

Preferably, the processing system is configured to measure a density of a fluid and determine a solute added to the fluid is substantially fully dissolved based upon a combination of changes in the drive gain and the measured density of the fluid.

Preferably, the processing system is configured to determine a solute added to the fluid is substantially fully dissolved when a drive gain signal peak is followed by a drive gain signal stabilization period.

Preferably, the drive gain signal stabilization period comprises a signal level that is approximately the signal level observed prior to the measured drive gain signal peak.

Preferably, the drive gain signal stabilization period comprises a signal level that is different from the signal level observed prior to the measured drive gain signal peak.

Preferably, the vibratory meter further comprises a recirculation loop in fluid communication with the vibratory meter, and a vessel operable to contain the fluid, wherein the fluid may pass through the recirculation loop and the vibratory meter before returning to the vessel.

According to an aspect, a method of monitoring solute dissolution in a solution comprises the steps of adding a first solute to a fluid, exposing the fluid to a vibratory meter, measuring a drive gain of a driver of the vibratory meter, and determining the first solute is substantially fully dissolved based upon a change in the measured drive gain.

Preferably, the method comprises the steps of measuring a density of the fluid, and determining the solute is substantially fully dissolved based upon a change in the measured density of the fluid.

Preferably, the method comprises the steps of measuring a density of the fluid, and determining the solute is substantially fully dissolved based upon changes in the measured density of the fluid and the measured drive gain.

Preferably, the step of determining the first solute is substantially fully dissolved based upon the measured drive gain comprises measuring a drive gain signal peak followed by a drive gain signal stabilization period.

Preferably, the drive gain signal stabilization period comprises a signal level period that is approximately the signal level observed prior to the measured drive gain signal peak.

Preferably, the drive gain signal stabilization period comprises a signal level period that is different from the signal level observed prior to the measured drive gain signal peak.

Preferably, the method comprises the step of adding a second solute to the fluid only after it is determined that the first solute is substantially fully dissolved.

Preferably, the step of determining the first solute is substantially fully dissolved based upon the measured drive gain comprises the step of comparing the measured drive gain to a predetermined drive gain.

Preferably, the step of determining the first solute is substantially fully dissolved based upon the measured drive gain comprises the step of comparing the measured drive gain to a machine-learned drive gain.

Preferably, the step of determining the first solute is substantially fully dissolved based upon the measured density comprises the step of comparing the measured density to a predetermined density.

Preferably, the step of determining the first solute is substantially fully dissolved based upon the measured density comprises the step of comparing the measured density to a machine-learned density.

### BRIEF DESCRIPTION OF THE DRAWINGS

FIG. 1 illustrates a vibratory densitometer according to an embodiment;

FIG. 2 illustrates a vibratory densitometer according to an embodiment;

FIG. 3 illustrates another embodiment of a densitometer;

FIG. 4 illustrates meter electronics according to an embodiment;

FIG. 5 illustrates a schematic of a solute dissolution system according to an embodiment;

FIG. 6 is an example graph indicating solute addition to a monitored solution; and

FIG. 7 is another example graph indicating solute addition to a monitored solution.

### DETAILED DESCRIPTION OF THE INVENTION

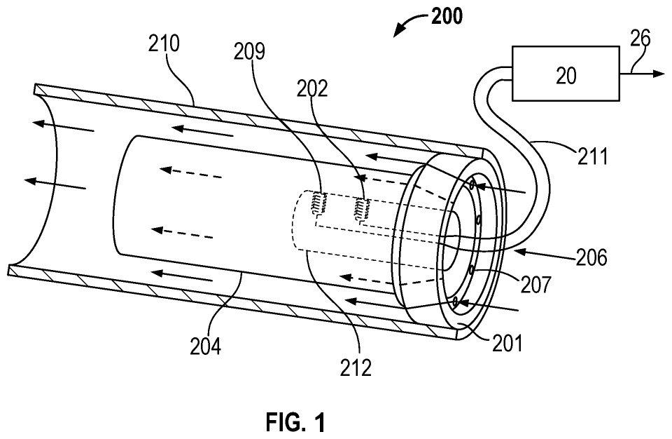

FIGS. 1-7 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

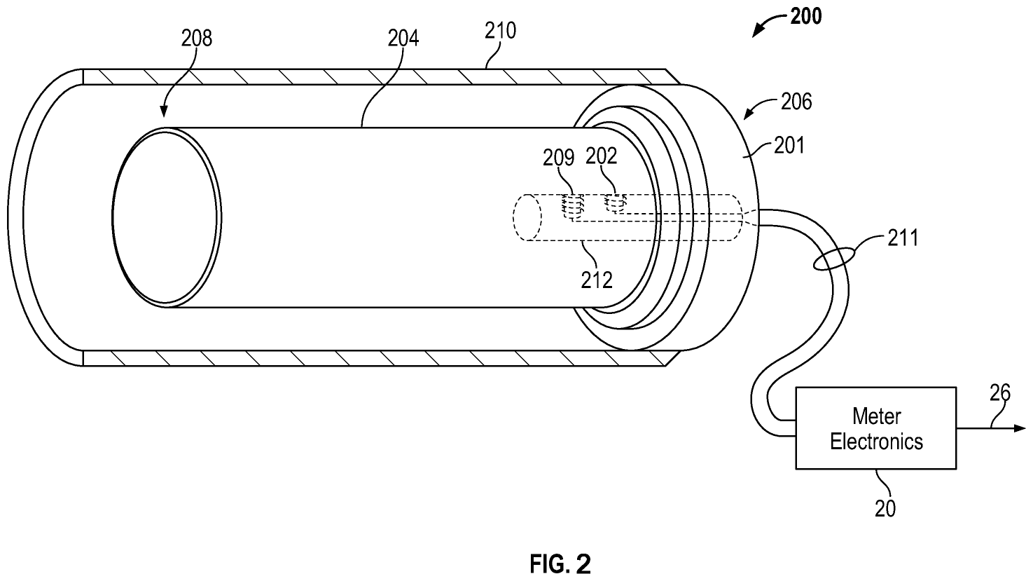

FIGS. 1 and 2 illustrate a densitometer 200. The vibrating member 204 may be vibrated at, or near, to a natural (i.e., resonant) frequency. By measuring a resonant frequency of the vibrating member 204 in a presence of a fluid, the density of the fluid can be determined. The vibrating member 204 may be formed of metal and is constructed of a uniform thickness so that variations and/or imperfections in the member's wall do not affect the resonant frequency of the vibrating cylinder. This example densitometer 200 includes a cylindrical vibrating member 204 located at least partially within a housing 210. The housing 210 or the vibrating member 204 may include flanges or other members for operatively coupling the densitometer to a pipeline or similar fluid delivering device in a fluid-tight manner. In the example shown, the vibrating member 204 is cantilever-mounted to the housing 210 at an inlet end 206, leaving the opposite end free to vibrate. The vibrating member 204 may include a plurality of fluid apertures 207 that allow fluid to enter the densitometer 200 and flow between the housing 210 and the vibrating member 204. Therefore, the fluid contacts the inside as well as the outside surfaces of the vibrating member 204. A driver 202 and a vibration sensor (pickoff) 209 are positioned proximate the vibrating member 204. The driver 202 receives a drive signal from a meter electronics 20 and vibrates the vibrating member 204 at or near a resonant frequency. The vibration sensor 209 detects the vibration of the vibrating member 204 and sends the vibration information to the meter electronics 20 for processing. The meter electronics 20 determines the resonant frequency of the vibrating member 204 and generates a density measurement from the measured resonant frequency.

According to an embodiment, the vibrating member densitometer 200 includes the vibrating member 204 inside a housing 210. The vibrating member 204 may be permanently or removably affixed to the housing 210. The fluid to be quantified may be introduced into, or may be passed through, the housing 210. The vibrating member 204 may be substantially coaxial within the housing 210 in some embodiments. However, the vibrating member 204 need not completely correspond to the housing 210 in cross-sectional shape. The vibrating member 204 may be a tube, rod, fork, or any other member known in the art.

In an embodiment, the vibrating member 204 is installed in the vibrating densitometer 200, and the inlet end 206 of the vibrating member 204 is coupled to the housing 210 while the outlet end 208 is free to vibrate. The vibrating member 204 is not directly coupled to the housing 210 in the embodiment shown, but instead the base 201 is coupled to the housing 210 and the outlet end 208 is free to vibrate. As a result, the vibrating member 204 is cantilever-mounted to the housing 210. This is merely an example, as other member mounting configurations are contemplated, and will be known to those skilled in the art.

According to an embodiment, the vibrating densitometer 200 can further include a driver 202 and at least one vibration sensor 209, which can be coupled to a central tower 212. The driver 202 can be adapted to vibrate the vibrating member 204 in one or more vibration modes. While the driver 202 is shown located within a central tower 212 positioned within the vibrating member 204, in some embodiments, the driver 202 may be positioned between the housing 210 and the vibrating member 204, for example. Furthermore, it should be appreciated that while the driver 202 is shown positioned closer to the inlet end 206, the driver 202 may be positioned at any desired location. According to an embodiment, the driver 202 can receive an electrical signal from the meter electronics 20 via leads 211. In the embodiment shown, the at least one vibration sensor 209 is coaxially aligned with the driver 202. In other embodiments, the at least one vibration sensor 209 may be coupled to the vibrating member 204 in other locations. For example, the at least one vibration sensor 209 may be located on an outer surface of the vibrating member 204. Further, the at least one vibration sensor 209 may be located outside the vibrating member 204 while the driver 202 is located inside the vibrating member 204, or vice versa.

The at least one vibration sensor 209 can transmit a signal to the meter electronics 20 via leads 211. The meter electronics 20 can process the signals received by the at least one vibration sensor 209 to determine a resonant frequency of the vibrating member 204. In an embodiment, the driver 202 and vibration sensor 209 are magnetically coupled to the vibrating member 204, thus the driver 202 induces vibrations in the vibrating member 204 via a magnetic field, and the vibration sensor 209 detects vibrations of the vibrating member 204 via changes in a proximate magnetic field. If a fluid under test is present, the resonant frequency of the vibrating member 204 will change inversely proportionally to the fluid density as is known in the art. The proportional change may be determined during an initial calibration, for example. In the embodiment shown, the at least one vibration sensor 209 also comprises a coil. The driver 202 receives a current to induce a vibration in the vibrating member 204, and the at least one vibration sensor 209 uses the motion of the vibrating member 204 created by the driver 202 to induce a voltage. Coil drivers and sensors are well known in the art and a further discussion of their operation is omitted for brevity of the description. Furthermore, it should be appreciated that the driver 202 and the at least one vibration sensor 209 are not limited to coils, but rather may comprise a variety of other well-known vibrating components, such as piezo-electric sensors, strain gages, optical or laser sensors, etc., for example. Therefore, the present embodiment should in no way be limited to magnets/coils. Furthermore, those skilled in the art will readily recognize that the particular placement of the driver 202 and the at least one vibration sensor 209 can be altered while remaining within the scope of the present embodiments.

The meter electronics 20 may be coupled to a path 26 or other communication link. The meter electronics 20 may communicate density measurements over the path 26. The meter electronics 20 may also transmit any manner of other signals, measurements, or data over the path 26. In addition, the meter electronics 20 may receive instructions, programming, other data, or commands via the path 26.

In an embodiment, the wall of the vibrating member 204 is excited in a radial direction and in a radial vibration mode by the driver 202 or other excitation mechanism. The wall of the vibrating member 204 will then vibrate in a corresponding radial mode, but at a resonant frequency of the elongated vibrating member 204 and the surrounding flow fluid. The relationship between the driving force of the vibration and the asymmetry of the tube wall will cause one or more mode shapes to be excited.

The vibrating member 204 separates the resulting vibration modes by at least a predetermined frequency difference, making discrimination between the vibration modes practical. Consequently, the vibrating densitometer 200 can filter or otherwise separate or discriminate the vibration modes picked up by the at least one vibration sensor 209. For example, the vibrating member 204 can separate and space apart a lower frequency radial vibration mode from a higher frequency radial vibration mode.

During construction of the vibrating member 204, the vibrating member 204 and the base 201 are formed. In an embodiment, the vibrating member 204 is at least partially formed by machining. In an embodiment, the vibrating member 204 is at least partially formed by electrical discharge machining. These methods provide non-limiting examples of potential construction techniques, and do not serve to limit the use of other construction techniques.

The vibrating member 204 may be the same piece of material as the base 201. In an embodiment, the vibrating member 204 is formed and subsequently affixed to the base 201. The vibrating member 204 may be welded or brazed to the base 201 in some embodiments. However, it should be understood that the vibrating member 204 may be affixed to the base 201 in any suitable manner, including being permanently or removably affixed to the base 201.

Although the discussion herein concerns a vibrating tube that is fixed at one end and free at the other end, it should be understood that the concepts and examples also apply to a tube that is fixed at both ends and is vibrated in a radial mode. Furthermore, a structure is described having a cylindrical vibrating member, although it will be apparent to those skilled in the art that the present invention could be practiced on a vibrating fork densitometer.

The vibrating densitometer 200 may be configured to determine a density of a fluid, such as a gas, a liquid, a liquid with entrained gas, a liquid with suspended particulates and/or gas, or a combination thereof. In some embodiments, the vibrating member densitometer 200 may be configured to determine the density of a liquid having a solute therein.

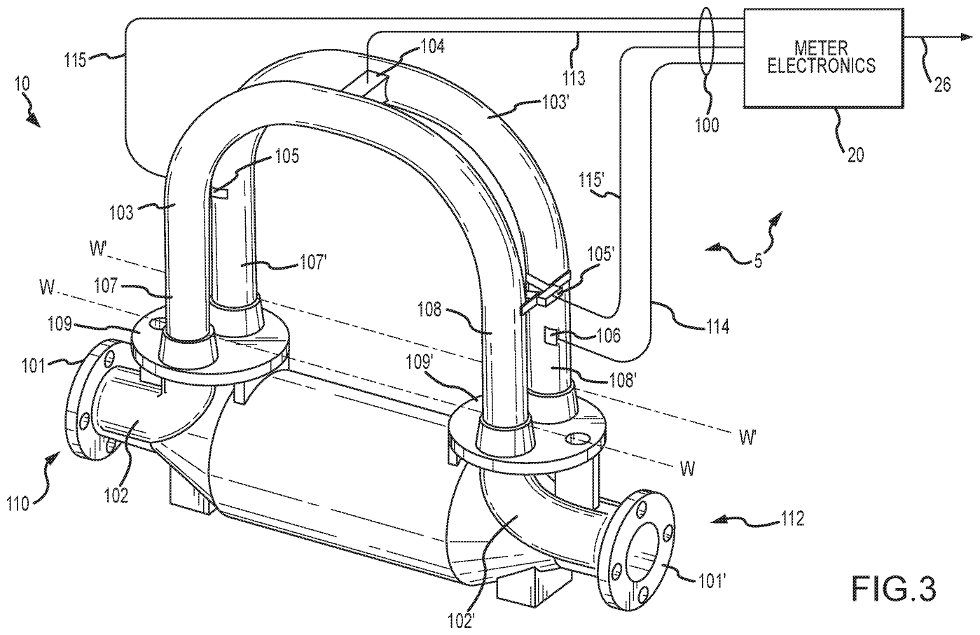

FIG. 3 illustrates a flowmeter 5, which can be any vibrating meter, such as a Coriolis flowmeter/densitometer, for example without limitation. The flowmeter 5 comprises a sensor assembly 10 and meter electronics 20. The sensor assembly 10 responds to mass flow rate and density of a process material. Meter electronics 20 are connected to the sensor assembly 10 via leads 100 to provide density, mass flow rate, and temperature information over path 26, as well as other information. The sensor assembly 10 includes flanges 101 and 101′, a pair of manifolds 102 and 102′, a pair of parallel conduits 103 (first conduit) and 103′ (second conduit), a driver 104, a temperature sensor 106 such as a resistive temperature detector (RTD), and a pair of pickoffs 105 and 105′, such as magnet/coil pickoffs, strain gages, optical sensors, or any other pickoff known in the art. The conduits 103 and 103′ have inlet legs 107 and 107′ and outlet legs 108 and 108′, respectively. Conduits 103 and 103′ bend in at least one symmetrical location along their length and are essentially parallel throughout their length. Each conduit 103, 103′, oscillates about axes W and W′, respectively.

The legs 107, 107′, 108, 108′ of conduits 103,103′ are fixedly attached to conduit mounting blocks 109 and 109′ and these blocks, in turn, are fixedly attached to manifolds 102 and 102′. This provides a continuous closed material path through the sensor assembly 10.

When flanges 101 and 101′ are connected to a process line (not shown) that carries the process material that is being measured, material enters a first end 110 of the flowmeter 5 through a first orifice (not visible in the view of FIG. 3) in flange 101, and is conducted through the manifold 102 to conduit mounting block 109. Within the manifold 102, the material is divided and routed through conduits 103 and 103′. Upon exiting conduits 103 and 103′, the process material is recombined in a single stream within manifold 102′ and is thereafter routed to exit a second end 112 connected by flange 101 to the process line (not shown).

Conduits 103 and 103′ are selected and appropriately mounted to the conduit mounting blocks 109 and 109′ so as to have substantially the same mass distribution, moments of inertia, and Young's modulus about bending axes W--W and W′--W′, respectively. Inasmuch as the Young's modulus of the conduits 103, 103′ changes with temperature, and this change affects the calculation of flow and density, a temperature sensor 106 is mounted to at least one conduit 103, 103′ to continuously measure the temperature of the conduit. The temperature of the conduit, and hence the voltage appearing across the temperature sensor 106 for a given current passing therethrough, is governed primarily by the temperature of the material passing through the conduit. The temperature-dependent voltage appearing across the temperature sensor 106 is used in a well-known method by meter electronics 20 to compensate for the change in elastic modulus of conduits 103, 103′ due to any changes in conduit 103, 103′ temperature. The temperature sensor 106 is connected to meter electronics 20.

Both conduits 103, 103′ are driven by driver 104 in opposite directions about their respective bending axes W and W′ at what is termed the first out-of-phase bending mode of the flowmeter. This driver 104 may comprise any one of many well-known arrangements, such as a magnet mounted to conduit 103′ and an opposing coil mounted to conduit 103, through which an alternating current is passed for vibrating both conduits. A suitable drive signal is applied by meter electronics 20, via lead 113, to the driver 104. It should be appreciated that while the discussion is directed towards two conduits 103, 103′, in other embodiments, only a single conduit may be provided or more than two conduits may be provided. It is also within the scope of the present invention to produce multiple drive signals for multiple drivers, and for the driver(s) to drive the conduits in modes other than the first out-of-phase bending mode.

Meter electronics 20 receive the temperature signal on lead 114, and the left and right velocity signals appearing on leads 115 and 115′, respectively. Meter electronics 20 produce the drive signal appearing on lead 113 to driver 104 and vibrate conduits 103, 103′. Meter electronics 20 process the left and right velocity signals and the temperature signal to compute the mass flow rate and the density of the material passing through the sensor assembly 10. This information, along with other information, is applied by meter electronics 20 over path 26 to utilization means. An explanation of the circuitry of the meter electronics 20 is not needed to understand the present invention and is omitted for brevity of this description. It should be appreciated that the description of FIGS. 1-3 are provided merely as examples of the operation of some possible vibrating meters and are not intended to limit the teaching of the present invention.

A Coriolis flowmeter structure is described although it will be apparent to those skilled in the art that the present invention could be, as noted above, practiced on a vibrating tube or fork densitometer without the additional measurement capability provided by a Coriolis mass flowmeter. Furthermore, the term vibrating or vibratory member may, herein, refer to conduits.

For vibrating member densitometers 200 to obtain accurate density measurements, the resonant frequency should ideally be stable. One approach to achieve the desired stability is to vibrate the vibrating member 204 in a radial vibration mode. In a radial vibration mode, the longitudinal axis of the vibrating member remains essentially stationary, while at least a part of the vibrating member's wall translates and/or rotates away from its rest position. Radial vibration modes tend to be self-balancing and thus, the mounting characteristics of the vibrating member are not as critical compared to some other vibration modes. However, other vibration modes are contemplated for the embodiments.

It is well understood that when there are two fluid phases with different densities present in a vibratory densitometer, there is decoupling that occurs between these two phases, and that the decoupling is a function of the difference in density of the carrier phase (liquid in this case) and the particle phase (solid) and the particle size, along with carrier phase viscosity and tube vibration frequency. This damping is a highly sensitive detection method of the presence of two phases. This damping presents itself in vibrating member densitometers in both drive gain and pickoff amplitude. In the case of gas in a liquid process, for example without limitation, the drive gain quickly rises from about 2-5% to approximately 100%.

The combined effect of damping on energy input and resulting amplitude is known as extended drive gain, which represents an estimate of how much power would be required to maintain target vibration amplitude, if more than 100% power were available:

$$Extended Drive Gain = Drive Gain * \frac{Drive Target}{( \frac{Max ( Left Pickoff , Right Pickoff )}{Frequency} )} \qquad ( 1 )$$

It should be noted that, for purposes of the embodiments provided herein, that the term drive gain may, in some embodiments, refer to drive current, pickoff voltage, or any signal measured or derived that indicates the amount of power needed to drive the meter at a particular amplitude. In related embodiments, the term drive gain may be expanded to encompass any metric utilized to detect multi-phase flow, such as noise levels, standard deviation of signals, damping-related measurements, and any other means known in the art to detect mixed-phase flow. In an embodiment, these metrics may be compared across the pick-off sensors in order to detect a mixed-phase.

The vibrating members take very little energy to keep vibrating at their first resonant frequency, so long as all of the fluid in the meter is homogenous with regard to density. In the case of the fluid consisting of two (or more) immiscible components of different densities, the vibration of the tube will cause displacement of different magnitudes of each of the components. This difference in displacement, or decoupling, and the magnitude of this decoupling has been shown to be dependent on the ratio of the densities of the components as well as the inverse Stokes number:

$$\begin{matrix}Density Ratio ≡ \frac{{ρ}_{fluid}}{{ρ}_{particle}} & ( 2 ) \\ Inverse Stokes number = \sqrt{\frac{2 {v}_{f}}{ω {r}^{2}}} & ( 3 )\end{matrix}$$

Where ω is the frequency of vibration, ν is the kinematic viscosity of the fluid, and r is the radius of the particle. It should be noted that the particle may have a lower density than the fluid, as in the case of a bubble.

Decoupling that occurs between the components causes damping to occur in the vibration of the tube, requiring more energy to maintain vibration, or reducing the amplitude of vibration, for a fixed amount energy input.

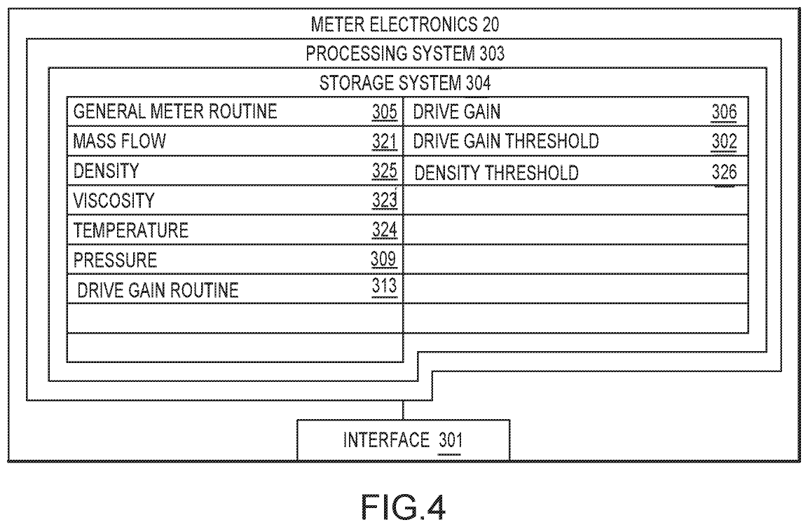

FIG. 4 is a block diagram of the meter electronics 20 according to an embodiment. In operation, the density meters 5, 200 provide various measurement values that may be outputted including one or more of a measured or averaged value of density, mass flow rate, volume flow rate, individual flow component mass and volume flow rates, and total flow rate, including, for example, both volume and mass flow of individual flow components.

The density meters 5, 200 generate a vibrational response. The vibrational response is received and processed by the meter electronics 20 to generate one or more fluid measurement values. The values can be monitored, recorded, saved, totaled, and/or output.

The meter electronics 20 includes an interface 301, a processing system 303 in communication with the interface 301, and a storage system 304 in communication with the processing system 303. Although these components are shown as distinct blocks, it should be understood that the meter electronics 20 can be comprised of various combinations of integrated and/or discrete components.

The interface 301 may be configured to couple to the leads 100, 211 and exchange signals with the driver 104, 202, pickoff/vibration sensors 105, 105′, 209, and temperature sensors 106, for example. The interface 301 may be further configured to communicate over the communication path 26, such as to external devices.

The processing system 303 can comprise any manner of processing system. The processing system 303 is configured to retrieve and execute stored routines in order to operate the meters 5, 200. The storage system 304 can store routines including a general meter routine 305 and a drive gain routine 313. The storage system 304 can store measurements, received values, working values, and other information. In some embodiments, the storage system stores a mass flow (m) 321, a density (p) 325, a density threshold 326, a viscosity (μ) 323, a temperature (T) 324, a pressure 309, a drive gain 306, a drive gain threshold 302, and any other variables known in the art. The routines 305, 313 may comprise any signal noted as well as other variables known in the art. Other measurement/processing routines are contemplated and are within the scope of the description and claims.

The general meter routine 305 can produce and store fluid quantifications and flow measurements. These values can comprise substantially instantaneous measurement values or can comprise totalized or accumulated values. For example, the general meter routine 305 can generate mass flow measurements and store them in the mass flow 321 storage of the storage system 304, for example. Similarly, the general meter routine 305 can generate density measurements and store them in the density 325 storage of the storage system 304, for example. The mass flow 321 and density 325 values are determined from the vibrational response, as previously discussed and as known in the art. The mass flow and other measurements can comprise a substantially instantaneous value, can comprise a sample, can comprise an averaged value over a time interval, or can comprise an accumulated value over a time interval. The time interval may be chosen to correspond to a block of time during which certain fluid conditions are detected, for example, a liquid-only fluid state, or alternatively, a fluid state including liquids, entrained gas, and/or solids, and or solutes. In addition, other mass and volume flow and related quantifications are contemplated and are within the scope of the description and claims.

A drive gain threshold 302 may be used to distinguish mixed-phase flow and monitor solute dissolution. Similarly, a density threshold 326 applied to the density 325 reading may also be used, separately or together with the drive gain, to distinguish mixed-phase flow and solute dissolution. Drive gain 306 may utilized as a metric for the sensitivity of the meter's 5, 200 conduit or vibratory member vibration to the presence of fluids of various states of solute dissolution, for example without limitation.

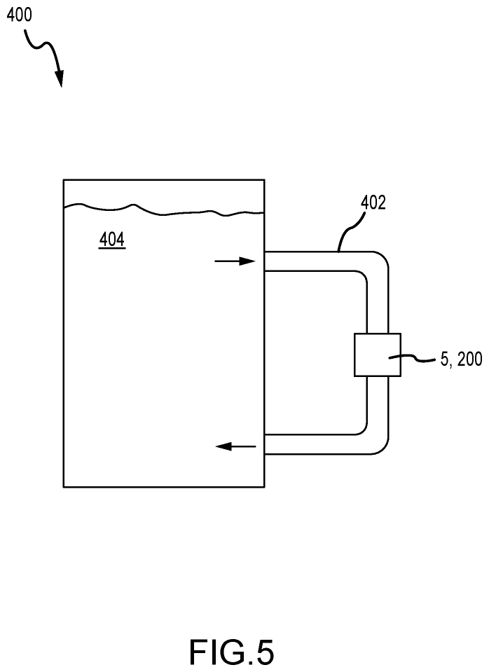

In an embodiment illustrated by FIG. 5, a process and system 400 for monitoring batch mixing operations comprises a density meter 5, 200 on a recirculation loop 402 of a vessel 404. Fluid may be propelled by a pump or similar device such that fluid recirculates through the vessel 404, recirculation loop 402, and the density meter 5, 200. As ingredients are sequentially added to solution, the change in density of the solution gives an indication of when and how much ingredient is added. This method ensures that no steps in the recipe are missed, and/or that no ingredients are left out of the batch. One of the other aspects of the process is the verification that an added ingredient is fully dissolved before the addition of the next ingredient to the solution. Additionally, the verification that no undissolved solids remain in a final product may be monitored.

It should be noted that besides recirculation, batch transfer is also contemplated. For example, fluid may be propelled by a pump or similar device such that fluid is transferred from the vessel 404, through the density meter 5, 200, and then to a second vessel. This method would provide a quality control measure, which could ensure that no steps in the recipe are missed, and/or that no ingredients are left out of a batch. An example, provided without limitation, would be for beverages where the producer desires to minimize the amount of solids present in retail containers. Installing a density meter 5, 200 to monitor for solids proximate a filling machine/dispenser, or the outlet of a storage tank where the solids would have settled, is an alternative to the recirculation installation described herein.

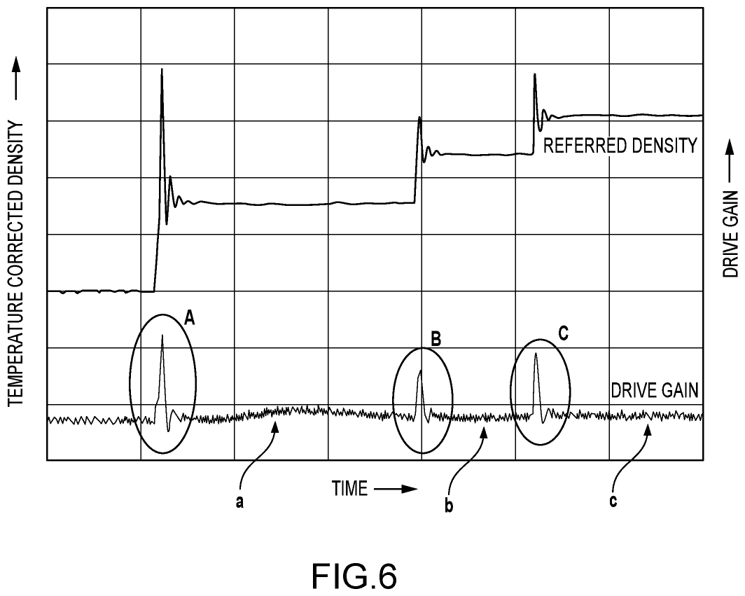

Turning to FIG. 6, a graph shows an example of how drive gain is utilized to detect the presence of solids in a solution by monitoring drive gain. In the example graph provided, solute is added at three points, A, B, and C. Drive gain sharply increases when the solute is added to solution, as indicated by peaks that correspond to solute additions A, B, and C. This is also accompanied by corresponding rises in density. The drive gain returns to a stable baseline, a, b, c, after peaking, and this indicates that the solute is solubilized. It should be noted that density trace stabilizes after each solute addition, but the solution density increases overall. In an embodiment, the detection of a stable post-solute-addition baseline indicates a solute has entered solution.

The drive gain peaks, A, B, C, are clearly discernable. However, in an embodiment, when the addition of solute has a substantial effect on density, such as that illustrated, density change and/or density stability may be utilized as a primary indicator of dissolution, with the drive gain utilized as a confirmatory variable.

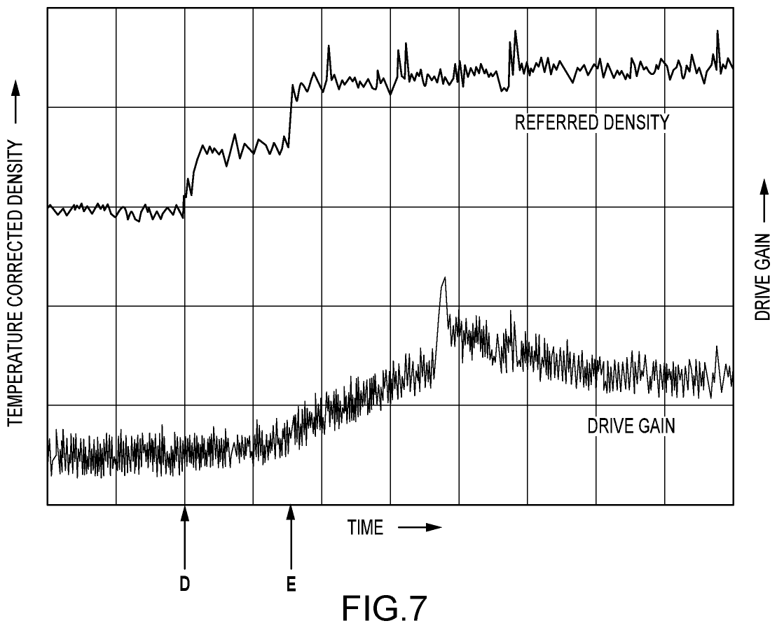

Turning to FIG. 7, a solute having a different dissolution profile than that illustrated in FIG. 6 is presented. In this example, solute addition at points D and E cause a slow increase in drive gain that levels off once the solute is solubilized. The drive gain then remains at this higher level. Again, this may be utilized as an indication of dissolution alone, or may be utilized as a secondary indicator, along with density, that the solute was added in the correct amount and that it is fully dissolved. An overall shift in nominal drive gain and density indicates that the solute was added in the correct amount, and the stability of drive gain signal indicates that the solute has dissolved fully.

The graphs of FIGS. 6 and 7 are provided merely as examples of potential solute addition measurements. The shape of the curves, intensity of the peaks, slopes, return to a baseline or not, and other characteristics illustrated are merely examples. It will be recognized by those skilled in the art that different solutes and different solutions will exhibit potentially unique curve shape, unique peak shape and size, unique slopes, unique return(s) to baseline, unique combinations of the aforementioned, and generally unique signatures and/or drive gain/density behaviors-far too many to illustrate.

In embodiments, signal signatures of each solute, multiple additions of the same solute, and/or overall recipe progression and finalization, are saved in a monitoring system, and solute addition may be monitored and verified. This reduces human error, and provides accurate verification that the desired solution is created. Each solute addition or overall recipe progression may be pre-programmed into meter electronics or in a device in communication with meter electronics. In yet another embodiment, a machine learning algorithm is trained to recognize distinct ingredients in a process by looking at the density and drive gain signatures, as will be understood by those skilled in the art. In an embodiment, if measured drive gain and/or density signatures differ from a predetermined or machine-learned drive gain and/or density signatures by more than a predetermined amount, an indication of such may be generated. Such an indication may include an alarm and/or a notification. In an embodiment, the drive gain routine 313 may be configured to perform drive gain and solute addition analyses as noted herein.

Many operations deal with mixing dry ingredients into a liquid process, yet most analytic instruments are employed for off-line sampling to monitor batch quality. By implementing time-domain analytics, the potential to perform dissolution, and thus quality monitoring, may be accomplished with a relatively inexpensive, yet extremely accurate, vibrating element density meter.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other vibrating systems, and not just to the embodiments described above and shown in the accompanying figures. Accordingly, the scope of the invention should be determined from the following claims.

We claim:

1. A vibratory meter (5, 200), comprising:
a driver (104, 202);
a vibratory member (103, 103′, 204) vibratable by the driver (104, 202);
at least one pickoff sensor (105, 105′, 209) configured to detect vibrations of the vibratory member (103, 103′, 204);
meter electronics (20) comprising an interface (301) configured to receive a vibrational response from the at least one pickoff sensor (105, 105′, 209), and a processing system (303) coupled to the interface (301) configured to:
measure a drive gain (306) of the driver (104, 202); and
determine a solute added to the fluid is substantially fully dissolved based upon a change in the drive gain (306).

2. The vibratory meter (5, 200) of claim 1, wherein the processing system (303) is configured to:
measure a density (325) of a fluid; and
determine a solute added to the fluid is substantially fully dissolved based upon a change in the density (325) of the fluid.

3. The vibratory meter (5, 200) of claim 1, wherein the processing system (303) is configured to:
measure a density (325) of a fluid; and
determine a solute added to the fluid is substantially fully dissolved based upon a combination of changes in the drive gain (306) and the measured density (325) of the fluid.

4. The vibratory meter (5, 200) of claim 1, wherein the processing system (303) is configured to determine a solute added to the fluid is substantially fully dissolved when a drive gain signal peak is followed by a drive gain signal stabilization period.

5. The vibratory meter (5, 200) of claim 4, wherein the drive gain signal stabilization period comprises a signal level that is approximately the signal level observed prior to the measured drive gain signal peak.

6. The vibratory meter (5, 200) of claim 4, wherein the drive gain signal stabilization period comprises a signal level that is different from the signal level observed prior to the measured drive gain signal peak.

7. The vibratory meter (5, 200) of claim 4, further comprising:
a recirculation loop (402) in fluid communication with the vibratory meter (5, 200); and
a vessel (404) operable to contain the fluid, wherein the fluid may pass through the recirculation loop (402) and the vibratory meter (5, 200) before returning to the vessel (404).

8. A method of monitoring solute dissolution in a solution comprising the steps of:
adding a first solute to a fluid;
exposing the fluid to a vibratory meter;
measuring a drive gain of a driver of the vibratory meter; and
determining the first solute is substantially fully dissolved based upon a change in the measured drive gain.

9. The method of claim 8, comprising the steps of:
measuring a density of the fluid; and
determining the solute is substantially fully dissolved based upon a change in the measured density of the fluid.

10. The method of claim 8, comprising the steps of:
measuring a density of the fluid; and
determining the solute is substantially fully dissolved based upon changes in the measured density of the fluid and the measured drive gain.

11. The method of claim 8, wherein the step of determining the first solute is substantially fully dissolved based upon the measured drive gain comprises measuring a drive gain signal peak followed by a drive gain signal stabilization period.

12. The method of claim 11, wherein the drive gain signal stabilization period comprises a signal level period that is approximately the signal level observed prior to the measured drive gain signal peak.

13. The method of claim 11, wherein the drive gain signal stabilization period comprises a signal level period that is different from the signal level observed prior to the measured drive gain signal peak.

14. The method of claim 8, comprising the step of adding a second solute to the fluid only after it is determined that the first solute is substantially fully dissolved.

15. The method of claim 8, wherein the step of determining the first solute is substantially fully dissolved based upon the measured drive gain comprises the step of comparing the measured drive gain to a predetermined drive gain.

16. The method of claim 8, wherein the step of determining the first solute is substantially fully dissolved based upon the measured drive gain comprises the step of comparing the measured drive gain to a machine-learned drive gain.

17. The method of claim 9, wherein the step of determining the first solute is substantially fully dissolved based upon the measured density comprises the step of comparing the measured density to a predetermined density.

18. The method of claim 9, wherein the step of determining the first solute is substantially fully dissolved based upon the measured density comprises the step of comparing the measured density to a machine-learned density.
